(19) United States
(12) Patent Application Publication
(10) Pub. No.: US 2023/0004799 A1
(43) Pub. Date: Jan. 5, 2023

(54) ONE-DIMENSIONAL-CONVOLUTION-BASED SIGNAL CLASSIFIER

(71) Applicant: SRI International, Menlo Park, CA (US)

(72) Inventor: Bradley Clymer, Denver, CO (US)

(21) Appl. No.: 17/852,954

(22) Filed: Jun. 29, 2022

Related U.S. Application Data
(60) Provisional application No. 63/217,179, filed on Jun. 30, 2021.

(51) Int. Cl. G06N 3/08

(52) U.S. Cl. CPC G06N 3/08

(57) ABSTRACT

An output module cooperates with a machine learning architecture to analyze parameter-varying signals. The signal-analyzing neural-network contains at least a one-dimensional-convolution layer to apply a series of i) a one-dimensional convolutional-based operation on the data of the parameter-varying signals ii) followed by a non-linear activation function on the data of the parameter-varying signals, under analysis, with multiple representations of the parameter-varying signals. Each representation of the parameter-varying signal is analyzed in a different domain in order to produce a classification of an entity into a specific category of an object corresponding to identifying features of the time-varying signals. Branches of the signal-analyzing neural-network are constructed to apply at least two or more successive layers of the one-dimensional-convolution layer followed by the non-linear activation function layer to values of time and frequency features of the parameter-varying signals, under analysis.

### CROSS-REFERENCE

This application claims priority under 35 USC 119 to U.S. provisional patent application Ser. 63/217,179, titled “one-dimensional-convolution-based signal classifier,” filed 30 Jun. 2021, which the disclosure of such is incorporated herein by reference in its entirety.

### TECHNICAL FIELD

Embodiments of this disclosure relate generally to artificial intelligence using a network to classify signals.

### BACKGROUND

Currently, identifying electromagnetic signals can be performed by manual or semi-automated observation of a given receiver's spectrum, and sometimes with a filter bank, or cyclostationary processing. A limit is imposed by the need to guess at what might already be there, as well as the computational complexity of performing the search in real time. Thus, there is a need to identify electromagnetic signals without any prior knowledge of their presence or type.

### SUMMARY

Provided herein are various methods, apparatuses, and systems for an artificial intelligence architecture.

In an embodiment, the output module can work with one or more processors to execute instructions and a memory to store data and instructions. The output module cooperates with a machine learning architecture to analyze parameter-varying signals. The machine learning architecture uses a signal-analyzing neural-network. The signal-analyzing neural-network is trained with one or more machine learning algorithms on sampled data of the parameter-varying signals. The signal-analyzing neural-network contains at least a one-dimensional-convolution layer to apply a series of i) a one-dimensional convolutional-based operation on the data of the parameter-varying signals ii) followed by a non-linear activation function on the data of the parameter-varying signals, under analysis, with multiple representations of the parameter-varying signals. Each representation of the parameter-varying signal is analyzed in a different domain. Each representation of the parameter-varying signal is analyzed in a different domain with the series of i) the one-dimensional convolutional-based operation on the data of the time-varying signals ii) followed by the non-linear activation function on the data of the parameter-varying signals, under analysis, in order to produce a classification of an entity into a specific category of an object corresponding to identifying features of the parameter-varying signals.

One or more branches of the signal-analyzing neural-network can be constructed to apply at least two or more successive layers of the one-dimensional-convolution layer to apply the one-dimensional-convolution based operation followed by the non-linear activation function layer to apply the non-linear activation function to data values of time and frequency in the time-varying signals, under analysis.

These and many more embodiments are discussed.

### DRAWINGS

FIG. 1 illustrates a block diagram of an embodiment of an example device containing an output module configured to work with one or more machine learning architectures that use a signal-analyzing neural-network;

FIG. 2 illustrates a diagram of a machine learning architecture with 1) a preprocessing section that expands the data of the parameter-varying signals, under analysis, from one dimension to multiple dimensions, 2) a feature extraction section that uses successive layers of a series of i) a one-dimensional convolutional-based operation on the data of the parameter-varying signals ii) followed by a non-linear activation function on the data of the parameter-varying signals, under analysis, with multiple representations of the parameter-varying signals, and 3) a classification section that classifies the parameter-varying signals under analysis into a specific category (from multiple different possible categories) based on the extracted features.

FIG. 3 illustrates a block diagram of an embodiment of an example machine learning architecture that uses a signal-analyzing neural-network with at least a one-dimensional convolutional-based operation on the sampled data of the time-varying signals under analysis;

FIGS. 4A and 4B illustrate block diagrams of an embodiment of another embodiment of an example machine learning architecture that uses a signal-analyzing neural-network to contain a one-dimensional-convolution layer to apply a one-dimensional convolutional-based operation on the sampled data of the time-varying signals followed by a non-linear activation function layer on the sampled data of the time-varying signals under analysis;

FIG. 5 illustrates a diagram of a number of electronic systems and devices communicating with each other in a network environment in accordance with an embodiment of the device with the machine learning architecture that use a signal-analyzing neural-network; and

FIG. 6 illustrates a diagram of an embodiment of a computing device that can be a part of the systems associated with the device and its associated modules and the machine learning architecture discussed herein.

While the design is subject to various modifications, equivalents, and alternative forms, specific embodiments thereof have been shown by way of example in the drawings and will now be described in detail. It should be understood that the design is not limited to the particular embodiments disclosed, but—on the contrary—the intention is to cover all modifications, equivalents, and alternative forms using the specific embodiments.

### DESCRIPTION

In the following description, numerous specific details can be set forth, such as examples of specific data signals, named components, number of frames, etc., in order to provide a thorough understanding of the present design. It will be apparent, however, to one of ordinary skill in the art that the present design can be practiced without these specific details. In other instances, well known components or methods have not been described in detail but rather in a block diagram in order to avoid unnecessarily obscuring the present design. Further, specific numeric references such as the first server, can be made. However, the specific numeric reference should not be interpreted as a literal sequential order but rather interpreted that the first server is different than a second server. Thus, the specific details set forth can be merely exemplary. The specific details can be varied from and still be contemplated to be within the spirit and scope of the present design. The term “coupled” is defined as meaning connected either directly to the component or indirectly to the component through another component.

Described herein includes machine learning architectures that can operate on signals, such as complex-valued Radio Frequency data, and provide a subsequent classification. The machine learning architectures use machine learning algorithms to automatically identify any time-varying signal types on which it is trained.

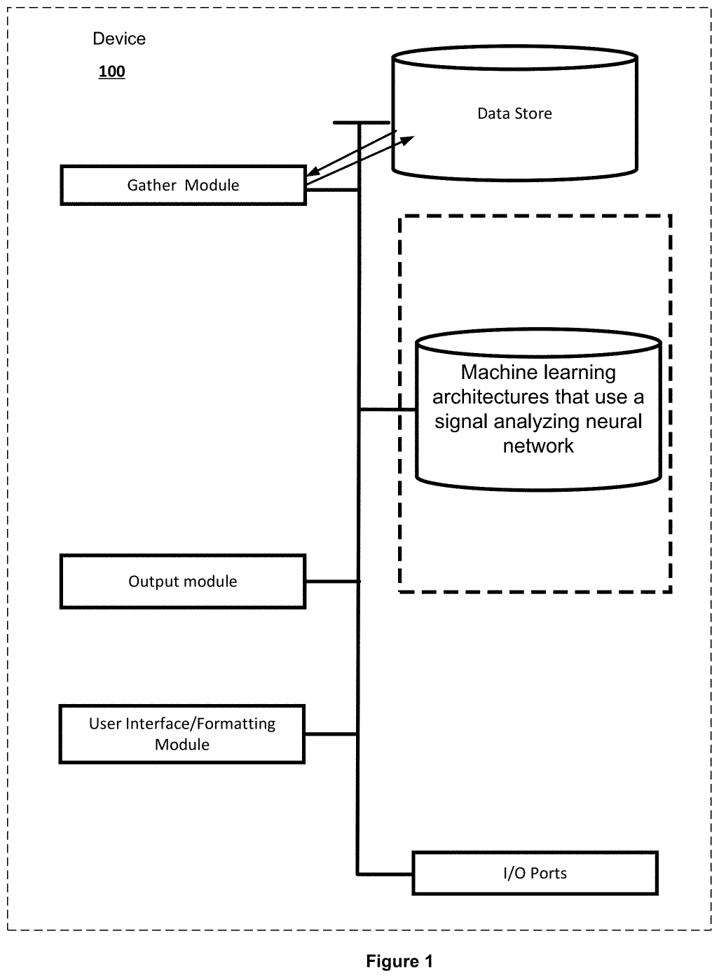

FIG. 1 illustrates a block diagram of an embodiment of an example device containing an output module configured to work with one or more machine learning architectures that use a signal-analyzing neural-network.

The device 100 may include a gather module, an output module, a formatting module, a data store, and one or more machine learning architectures trained with machine learning on time-varying signals. Note, the formatting module and the user interface may be implemented as one module or separate modules.

The gather module can collect the data, such as time-varying signals, from sensors to be analyzed. The gather module can also get data from the data store to be used in the analysis.

The output module can be configured to work with one or more processors to execute instructions and one or more memories to store data and instructions. The output module can be configured to analyze and assess the outputted results of one or more of the machine learning architectures trained with machine learning on time-varying signals using a convolution operation.

The output module cooperating with the one or more machine learning architectures is configured to analyze a group of two or more time-varying signals (e.g. electromagnetic signals, sound waves, radio frequency waves, etc.) composed of complex-valued features/parameters. The complex-valued features/parameters include can include i) real and imaginary valued features/parameters, ii) real-valued features/parameters, iii) imaginary-valued features/parameters, and iv) any combination of these features/parameters. Complex numbers/valued data can be one-dimensional data with two-dimensional vectors whose components are the so-called real part and imaginary part. Note, a real-valued wave magnitude is being measured, but the measurement is captured in the real and imaginary parts of the number in equally real ways; the complex nature captures the phase relative to a reference oscillator, and is a very real thing.

The data store cooperates with the data gather module to collect and maintain historical data of processes and their connections, including sensor data, meta data for the sensor data, etc., which is updated over time as the device 100 is in operation.

The output module can be configured to analyze and assess the outputted results of one or more of the machine learning architectures trained with machine learning. The output module can be configured to cooperate with one or more of the machine learning architectures trained with machine learning to supply the initial data and/or any supplemental data subsequently requested by the artificial intelligence architecture.

The data gather module with the output module cooperates to supply further data and/or metrics requested by the output module.

The device 100 is configurable by its user interface, by a user, enabling the user to customize and configure various settings as well as supply input data for use by the output module and/or the machine learning architectures.

The formatting module cooperates with the output module to output a formalized report as well as different parameters for a human user's consumption in a medium of any of 1) printable report, 2) presented digitally on a user interface, 3) in a machine-readable format for further use in machine-learning reinforcement and refinement, or 4) any combination of the three. The indications can be a classification of detected objects, various parameters, and other types of information. The formatting module can generate an output such as a printed or electronic report with the relevant data and calculations of how the classification was made, etc.

The data store can store the data and meta data metrics for a period of time. In one embodiment, that can be at least 27 days. In other embodiments, this time can vary. This corpus of data is fully searchable. The data gather works with probes and/or sensors to monitor time-varying signal traffic and store and record the data and metadata associated with the time-varying signal traffic in the data store.

The formatting module, cooperating with the output module, the gather module, and the machine learning architectures, can cooperate to present a representation of an output result from the machine learning architecture to be shown on a display screen indicating the specific category that the entity is classified to belong to from the sampled data of time-varying signals under analysis, without any prior knowledge of a presence or a type of the classified entity corresponding to the actually being contained or present within the radio frequency data, currently under analysis, in real time. In real time can be a time period of less than 500 microseconds from a time the probe/sensor receives the reflection of a time-varying signal, the analysis on the values and features of the reflection of a time-varying signal into a category, and then the display of that information onto a display screen. Note, the sampled data of time-varying signals under analysis is sampled at a fixed rate, such as one sample every two milliseconds, etc.

A motivation for this approach is the speed of one-dimensional convolutions, owing directly to their single dimensionality. Similar to that of classical matched filter techniques, real one-dimensional convolutions require O(N²) operations, for a filter of length N. In comparison to two-dimensional convolutions—which require O(N⁴) operations—the appeal of reducing operational dimensionality is clear. The constructed machine learning architecture will, in an example implementation, use successive series of hundreds of filters of length N (which also can be hundreds or thousands) in the one-dimensional convolutions acting as a filter; and thus, the one-dimensional convolutions save a huge amount of computation cycles and thus corresponding lower lag time and lower power consumption compared to for example a two-dimensional implementation. The computations and effects from the one-dimensional convolution operations allow a network based upon this type of architecture to achieve high accuracy as well as computational efficiency. The disclosed methods and apparatuses can also rely on a unique multiple value data representation and corresponding architecture.

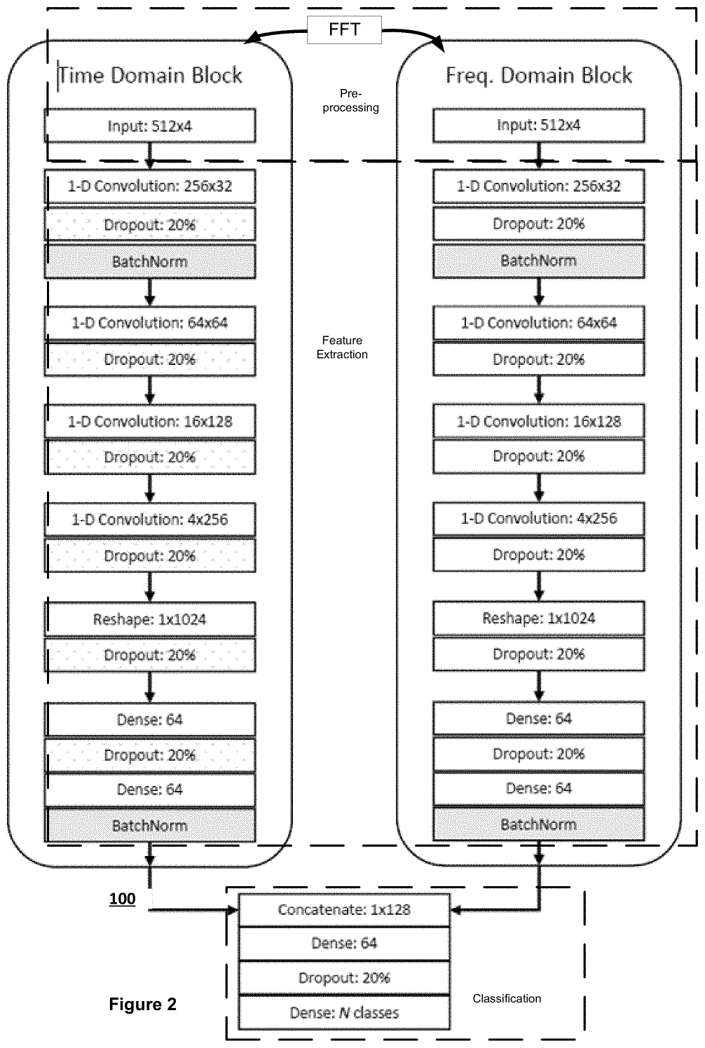

FIG. 2 illustrates a diagram of a machine learning architecture with 1) a preprocessing section that expands the data of the parameter-varying signals, under analysis, from one dimension to multiple dimensions, 2) a feature extraction section that uses successive layers of a series of i) a one-dimensional convolutional-based operation on the data of the parameter-varying signals ii) followed by a non-linear activation function on the data of the parameter-varying signals, under analysis, with multiple representations of the parameter-varying signals, and 3) a classification section that classifies the parameter-varying signals under analysis into a specific category (from multiple different possible categories) based on the extracted features. FIG. 2 essentially illustrates a high level overview of the operations being performed by the machine learning architecture. The parameter-varying signals can be time-varying, space-varying, spectral-line-varying (gas spectrometer), etc. Below time-varying signals under analysis will be used as an example of the parameter-varying signals under analysis. The preprocessing section takes in a one dimensional parameter varying signal, breaks that into multiple different representations that each is represented in multiple different dimensions and then puts the multi-dimensional representation into a given domain for analysis within that domain.

In an embodiment, an output module works with one or more processors to execute instructions and one or more memories to store data and instructions. The output module cooperates with a machine learning architecture to analyze time-varying signals. The machine learning architecture uses a signal-analyzing neural-network. Prior to deployment of the machine learning architecture composed with the signal-analyzing neural-network, the signal-analyzing neural-network is trained with labeled data and one or more supervised machine learning algorithms on sampled data of time-varying signals. The signal-analyzing neural-network contains a one-dimensional-convolution layer to apply, during deployment, a one-dimensional convolutional-based operation on the sampled data of the time-varying signals followed by a non-linear activation function layer on the sampled data of the time-varying signals, under analysis, in order to produce a classification of an entity into a specific category of an object corresponding to identifying features of the time-varying signals. Two or more branches of the signal-analyzing neural-network can be constructed to apply at least two or more successive layers of the one-dimensional-convolution layer to apply the one-dimensional-convolution based operation followed by the non-linear activation function layer to values of time and frequency features of the time-varying signals, under analysis.

The signal-analyzing neural-network is constructed to include a first branch where input values of the parameter-varying signals in a first domain are supplied into the first branch of the signal-analyzing neural-network. A first one-dimensional-convolution layer in the first branch is configured to apply the one-dimensional convolutional-based operation on the input values of the parameter-varying signals in the first domain. A second branch has input values of the parameter-varying signals in a second domain supplied into the second branch of the signal-analyzing neural-network. A second one-dimensional-convolution layer in the second branch is configured to apply the one-dimensional convolutional-based operation on the input values of the parameter-varying signals in a second domain at a same time with operations in the first branch. Again, below time-varying signals, such as Radio Frequency waves under analysis will be used as an example of the parameter-varying signals under analysis in the Time and Frequency domains expanded from one dimension to multiple dimensions such as eight dimensions and then classified into a specific object.

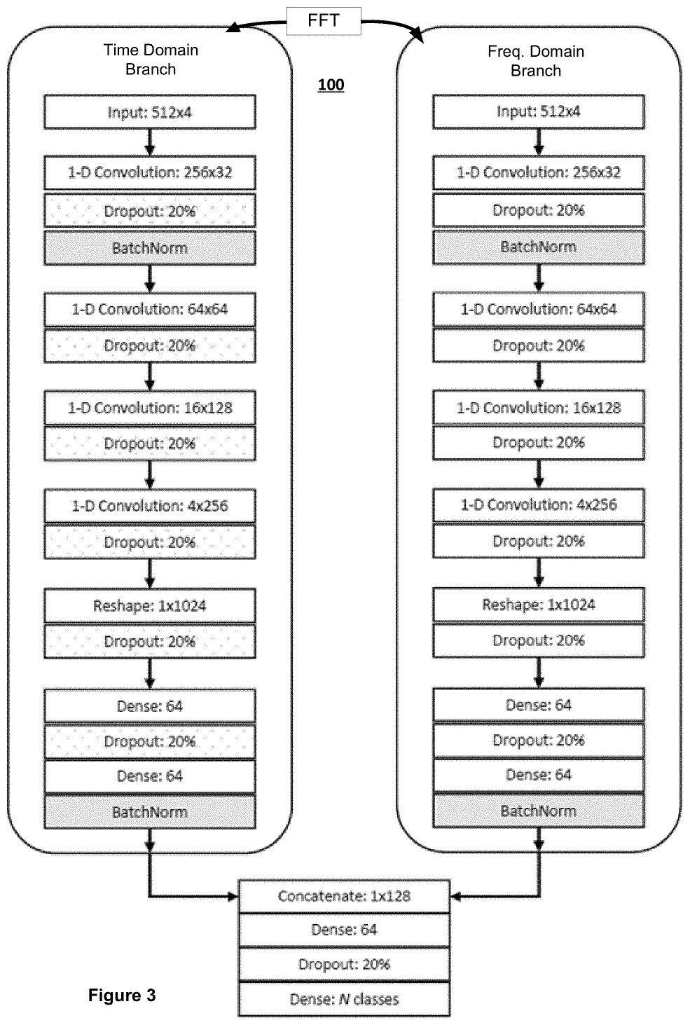

FIG. 3 illustrates a block diagram of an embodiment of an example machine learning architecture that uses a signal-analyzing neural-network with at least a one-dimensional convolutional-based operation on the sampled data of the time-varying signals under analysis.

In general, data for time-varying signals, such as Radio Frequency signals, are complex-valued, but very few machine learning networks are optimized for handling complex-valued data. To address this, in some embodiments, the disclosed apparatuses and methods implement a complexity tradeoff in the representation of input data, expanding a single 1-dimensional time signal into an 8-dimensional time-and-frequency representation. The intent is to learn increasingly non-linear features of the time and frequency domains and combine these representations in later portions of the network for classification of those input signals into a category or a reduction of input dimensionality for post-processing.

The one-dimensional complex-valued signal can be represented as a real-valued 8-dimensional matrix where real-imaginary, magnitude, and phase values for both the time-domain representation of the signal, and its corresponding frequency-domain representation uses the Fast Fourier Transform. For the two-domain case, there are four values each; and thus, eight total dimensions total. The values for the features can be i) in both the time and frequency domain, ii) each with their real and imaginary parts, iii) along with corresponding magnitude and phase information.

The series of one-dimensional convolution operations (applications of are performed on the time and frequency domains separately, but in parallel, and then these representations can be combined at the later layers of the network. Note, in mathematics, a convolution can be a mathematical operation on two functions (f and g) that produces a third function (f*g) that expresses how the shape of one is modified by the other. The convolution can be the integral of the product of the two functions after one is reversed and shifted. The integral is evaluated for all values of shift, producing the convolution function. One-dimensional convolutional neural networks (CNNs) can be considered as modified filter banks. Note, a convolutional neural network can be a class of artificial neural network which use multilayer perceptrons. Multilayer perceptrons usually mean fully connected networks, that is, each neuron in one layer is connected to all neurons in the next layer. In the case of the one implementation of a signal classifier based on one-dimensional convolutional neural networks, a parallel set of these convolution-based filter banks are trained in separate branches, and then concatenated in the final layers, as seen in FIG. 3. During deployment of the machine learning architecture, the machine learning architecture can analyze sampled data in different domains in separate branches, and then concatenate in the final portions of the network, as seen in FIG. 3.

The one or more machine learning architectures are configured to use a signal-analyzing neural-network 100 composed of two or more branches. The machine learning architectures can be implemented as an Artificial Intelligence classifier, an Artificial Intelligence model, etc. Prior to deployment of the machine learning architecture composed of a signal-analyzing neural-network 100 with two or more branches, the signal-analyzing neural-network 100 is trained with labeled data of time varying signals and one or more supervised machine learning algorithms (linear regression, random forest, support vector machines, etc. on the sampled data. The time-varying signals have values associated with the features for the time-varying signals. The signal-analyzing neural-network 100 is trained to recognize the values and features for the time-varying signals associated with different objects. During deployment, the signal-analyzing neural-network 100 is configured to contain a one-dimensional-convolution layer to apply a one-dimensional convolutional-based operation on the sampled data of the time-varying signals followed by a non-linear activation function layer on the sampled data of the time-varying signals, such as complex-valued radio frequency data, in order to produce a classification of an entity into a specific category of radio frequency source [e.g. radar reflection, digital radio signal] corresponding to identifying values and features of the time-varying signals. Note, the classification is derived from the training data on the values and features of time-varying signals corresponding to different known sources such as objects—drone, rocket, bird, etc.

The classification is derived from the training data on the values and features of time-varying signals with the one or more supervised machine learning algorithms objects from a group of two or more possible categories of objects.

The measured values of the sampled data of time-varying signals under analysis can be supplied to the machine learning architectures using the signal-analyzing neural-network 100 through a multiple value data structure (e.g. matrix) with real and imaginary values, a set of vectors, etc. The signal-analyzing neural-network 100 can expand values for a one-dimensional time signal provided in a data matrix into an eight-dimensional time-and-frequency representation at the output of the signal-analyzing neural-network 100, which will provide a wider amount of values and features that can be associated with each different potential type of object being classified into a specific category.

Progressing Down the Example Machine Learning Architecture

A multiple value data structure can be used to supply different values of the sampled data of the time-varying signals under analysis to the signal-analyzing neural-network 100. The multiple value data structure to supply the different values of the sampled data of the time-varying signals can be a mathematical matrix supplying the different values as a one-dimensional time signal that is expanded into an eight-dimensional time-and-frequency representation via operations performed by and within the signal-analyzing neural-network 100. For an example matrix:

| | | | |
|---|---|---|---|
| 1 | 2 | . . . | N |
| 2 | 1 | 9 | −13 |
| ↓ | −3 | 7 | 4 |
| N | −6 | 5 | 8 |

The neural network has an input block to input/consume values for the time-varying signals in a time domain, where the input block is configured to apply a Fast Fourier Transform on the input values for the time-varying signals under analysis from the time domain in order to produce values for the time-varying signals under analysis in the frequency domain. The Fast Fourier Transform is the very first thing that happens. The Fast Fourier Transform is what turns the values for the time parameters for the time-varying signal submitted as an input to the time branch of the neural network into the input to the frequency branch of the neural network.

In this example, input values for 512 samples of the time-varying signals, via the Fast Fourier Transform, becomes 512 time domain samples and 512 frequency domain samples, which are represented as i) real, ii) imaginary, iii) magnitude, and iv) phase values for the time-varying signals.

One or more portions, such as layers, of the signal-analyzing neural-network 100 are constructed to include:
i) a left branch (e.g. a hierarchical layer and/or a parallel branch on a same layer) where input values of the time-varying signals in a time domain are supplied into and operated upon in the left branch of the signal-analyzing neural-network 100. Multiple one-dimensional-convolution layers in the left branch are configured to apply the one-dimensional convolutional-based operation on the input values of the time-varying signals in a time domain, under analysis, and
ii) a second branch (e.g. a second layer and/or a parallel branch) where input values of the time-varying signals are supplied into and operated upon in the right branch of the signal-analyzing neural-network 100. Multiple one-dimensional-convolution layers in the right branch are configured to apply the one-dimensional convolutional-based operation on the input values of the time-varying signals in a frequency domain, under analysis, at a same time and/or in parallel with the operations in the left branch.

In this example, two (or more) branches of the signal-analyzing neural-network 100 are constructed to apply two or more successive layers of the one-dimensional-convolution layer to apply the one-dimensional-convolution based operation followed by the non-linear activation function layer to values of time and frequency features of the time-varying signals.

The neural network can be a sequence of multiple iterations of the one-dimensional convolutional-based operation followed by a non-linear activation function in order to change each output of the one-dimensional convolutional-based operation from linear to non-linear.

Note, conceptually, this architecture starts with a small number of short filters (e.g. one-dimensional conventional filters) early in the branches, and progressively increases the number of filters later in the network. This captures an increasingly non-linear set of feature relations as signals propagate through the machine learning architecture. The example machine learning architecture doubles the number of filters in subsequent layers of the network, from 32 up to 256.

Overall, an output result (e.g. representation) in the time domain is generated by the left branch of the signal-analyzing neural-network 100. An output result (e.g. representation) in the frequency domain is generated by the right branch of the signal-analyzing neural-network 100. The output results from the left branch on the time domain and the right branch on the frequency domain of the signal-analyzing neural-network 100 are combined (e.g. concatenated) in a later portion (e.g. 2nd layer or a 3rd layer) of the signal-analyzing neural network.

In an embodiment, the signal-analyzing neural-network 100 can be a convolutional neural network architecture built with a parallel set of one-dimensional-convolution layers, used as filter banks, and non-linear activation function layers after each filter bank, and then concatenation layer in a final portion of the signal-analyzing neural-network 100 to merge the output results from the parallel set of filter banks and non-linear activation function layers.

Again, input values for 512 samples of the time-varying signals, via the FFT becomes 512 time domain samples and 512 frequency domain samples, which are represented as real and imaginary i) magnitude values and ii) phase values. The example machine learning architecture doubles the number of filters in subsequent layers of the network, from 32 up to 256. In the layer below the input layer, the first filter block has 32 convolutional filters of length 256 to operate on the frequency domain [and the same occurs in the time domain in the other branch of the network] to change the shape of the 512 frequency samples from the input block into 256 frequency samples at the output of the filter block.

Generally, each filter layer/block frequency data samples are being operated upon to change the shape of the data by ratio that the designer choses, such as a multiplier of four. The second filter block has 64 convolutional filters of length 64 to operate on the frequency domain [and the same occurs in the time domain in the other branch of the network] to change the shape of the 256 frequency samples from the output of a first non-linearity function block into 64 frequency samples at the output of the filter block.

Next, all of the output numbers from each convolution operation/filter such as 256 outputs from the upstream convolution block are supplied to the input of each of the neuron blocks of the non-linearity function, then they're all added up and pass through a non-linearity in that non-linearity function block and then the output of that is passed to the next layer block. Each neuron block can have varying weights so that the inputs come from the outputs of the previous layer/block but due to the varying weights the output values will vary. The same process occurs at the next layer of neurons. All of the inputs from all the previous layers are added up and then pass through a non-linearity and that gives some value. The neural network contains a sequence of multiple iterations of one-dimensional convolutional layers. Each one-dimensional convolutional layer is configured to apply the one-dimensional convolutional-based operation followed by the non-linear activation function layer in order to change each output of each one-dimensional convolutional layer from a linear feature of the time-varying signal to a non-linear feature. Thus, in each branch, after each convolution operation/filter, there is a non-linear activation function block that transforms the output from being a linear representation of its inputs to a non-linear one. Also, the more layers of non-linearity in the constructed network, the more non-linear phenomenology the architecture can approximate. The amount of successive filters/convolution operations and non-linearity functions created in the network is set to be enough to statistically close to 100% of the time, based on the type of time-varying signal being analyzed and an amount of categories to classify, transform a linear value over to the non-linear function to produce a classification of an entity into a specific category of a source, such as an object, corresponding to identifying features of the time-varying signals with a reliability of, for example, 95%. In another embodiment, the amount of successive filters/convolution operations and non-linearity functions created in the network is set to be enough to produce a classification of an entity into a specific category of an object corresponding to identifying features of the time-varying signals with a reliability of, for example, 99%. In another embodiment, the amount of successive filters/convolution operations and non-linearity functions created in the network is set to be enough to produce a classification of an entity into a specific category of an object corresponding to identifying features of the time-varying signals with a reliability of, for example, 99.9%.

In the example architecture, there are two additional filter blocks in a series of filter blocks feeding non-non-linearity function blocks and then a data reshaping block is next in the network for each branch. Again an example number of 4 filter blocks are shown but far more filters could be in this series before the reshaping block.

Thus, the third filter block has 128 convolutional filters of length 16 to operate on the frequency domain [and similarly time domain in the other branch of the network] to change the shape of the 64 frequency samples from the output of a second non-linearity function block into 16 frequency samples at the output of the filter block.

Note, a rectified linear unit (ReLU) is an example of a non-linear activation function, meaning that is output is not a scalar (single number) multiple of its input, which can be observed on a typical X-Y graph as a line which is not straight. In the ReLU, for example, the function's graph has a bend at X=0, showing different behavior for positive and negative values of X. The rectified linear unit bends the output at the x-axis to cause a non-linearity.

A dropout layer exists in the branch but its purpose will be discussed later as its function aids most during the training of this signal-analyzing neural-network 100.

Finally, batch normalization layers are inserted in, for example, the first and fourth layers of the network, for the purpose of improving stability, by centering and scaling activations to achieve a fixed mean and variance, thereby reducing internal covariate shift within the network.

Next, the branch in the example network has a reshaping block. The reshaping block is configured to reshape the current data for the samples roughly back to the dimensionality of the initial input samples. In this example machine learning architecture, the data is reshaped into 1024 frequency samples.

The first dense layer in the signal-analyzing neural-network 100 is where everything is connected to everything else, except that the data goes from 1024 into every point in every point in the 64 in that dense connection.

In the dense layers, all outputs of the neurons' are connected to the inputs of subsequent neurons and thus connected everywhere in a multilayer perceptron. The successive dense layers in the branches change the one-dimensional signal from the convolutional filters that is expanded into an 8-dimensional signal coming out of the successive dense layers.

The neural network uses two parallel branches of one-dimensional convolution neural networks, one for time, one for frequency, and a final portion of the signal-analyzing neural-network 100 combining the two parallel branches via a concatenation, and then two or more densely connected layers in the final portion of the network to decrease the dimensions to an amount of possible categories that the entity can be classified into.

The batch normalization block in the left branch supplies an output of a length 64 vector. The batch normalization block supplies in the right branch an output of a length 64 vector. The concatenation operation takes those two vectors and reshapes the data and combines them into a size 128.

The concatenation block merges the eight-dimensional time signal coming out of the time branch of the network and the eight-dimensional frequency signal coming out of the frequency branch of the network into an eight-dimensional time and frequency signal and changes the size of the data from an input 64 from the outputs of each branch to 128 at the output of the concatenation block.

The final fully-connected layers in the final portion of the network operate to condense the amount of samples. The fully-connected layers can perform nonlinearly bounding the input feature space.

Eventually, the output of the final stage of the fully-connected layer is equal to or approximately equal to an amount of different categories that the entity classified from the sampled data of time-varying signals, under analysis, can belong to.

For example, when the machine learning architecture with the signal-analyzing neural-network 100 is used for Automatic Target Recognition of electromagnetic signals. The Automatic Target Recognition of electromagnetic signals can use the signal-analyzing neural-network 100 to correspond and identify at least unmanned aircraft (UAS) systems in radar data without any prior knowledge of the UAS actually being present in the scene or the type of UAS present in the scene, in the sampled electromagnetic signals, in real time.

The signal-analyzing neural-network 100 is configured to apply successive one-dimensional-convolution layers followed by non-linear activation function layer on the sampled data of time-varying signals, such as sampled complex-valued radio frequency data, under analysis in order to produce a classification of an entity into a specific category of object into its specific category of drone, rocket, bird, etc. corresponding to identifying features of the time-varying signals. Classification occurs based on different reflections of electromagnetic signals. The machine learning is used to improve the classification of radar returns.

In summary, one representation of a one-dimensional complex-valued signal as a real value eight-dimensional matrix with real and imaginary magnitude values and phase values is supplied as input data for both the time domain representation of the time-varying signal and its corresponding frequency domain representation, via a fast Fourier transform, two domains for values each eight total dimensions.

Thus, the network combining a series of one-dimensional linear filters in the time domain branch and the frequency domain branch and eventually combines the sampled data under analysis together, then applies a dense layer.

In this example, the time domain and the frequency domain were processed and analyzed separately and then they are being combined together to produce a final output.

Note, that the both the functions of the batch normalization layer and the dropout layer can be used as conveniences during the pre-deployment training of the machine learning architecture. The dropout layer serves to prevent the network from fixating on any consistent features across samples, balancing learning across filters. The dropout layer at random zeroes out some of the vectors/samples being examined before they go to subsequent layers, so that the neural network can't get fixated on a particular feature/preventing over-emphasis of common features. The dropout functions can counter the computer dropping off minute differences mathematically due to typical computer rounding functions. In this case, the dropout function can be back-propagated through, so that error gets fed back through previous layers to update the numbers/values of the weights.

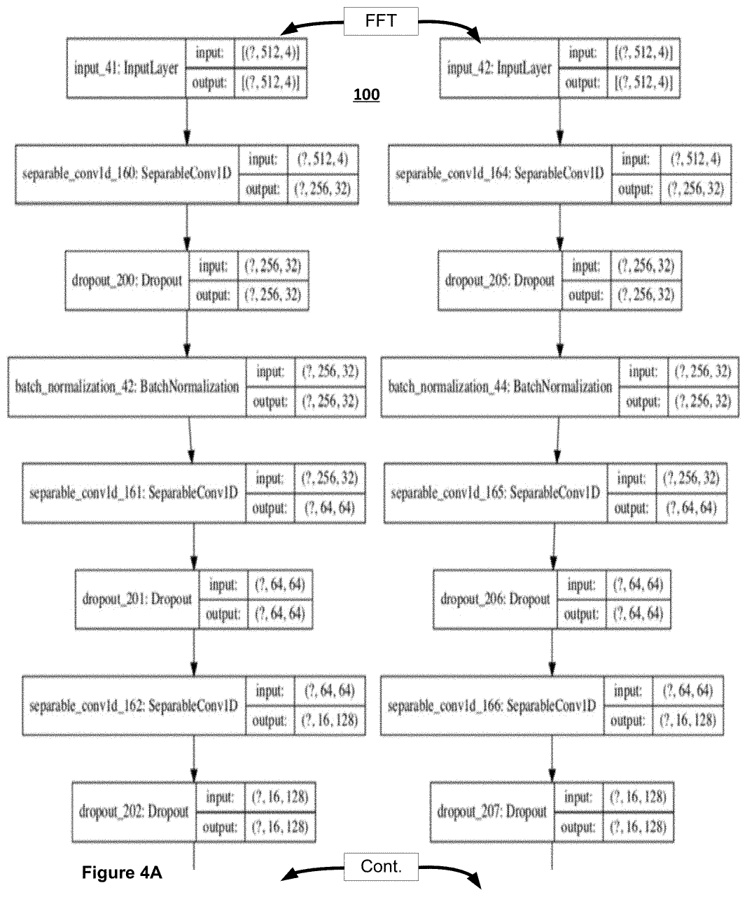

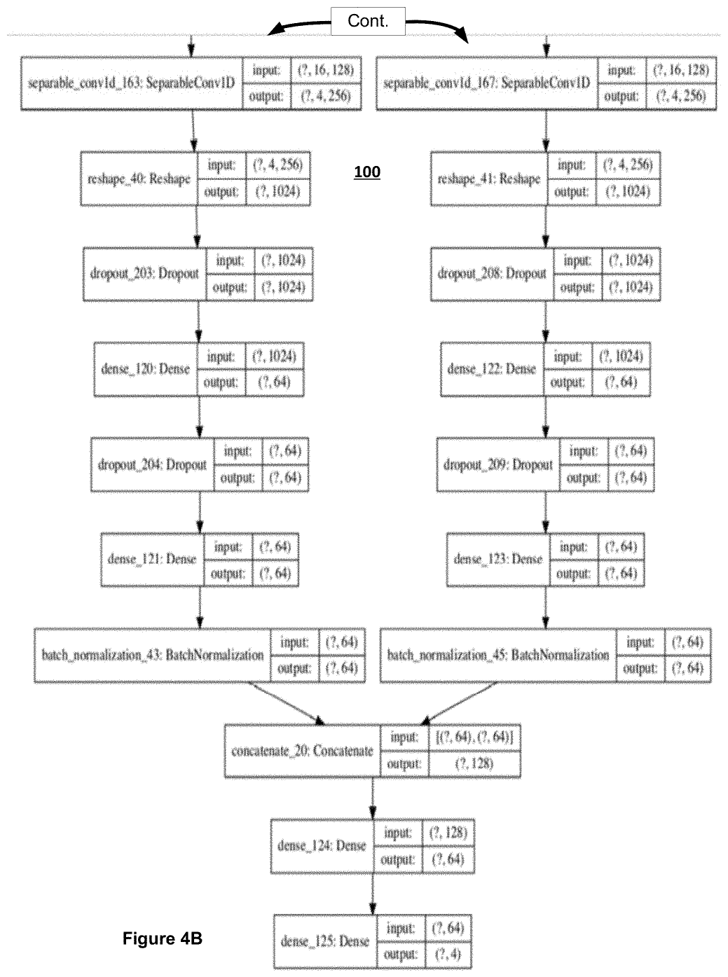

FIGS. 4A and 4B illustrate block diagrams of an embodiment of an example machine learning architecture that uses a signal-analyzing neural-network to contain a one-dimensional-convolution layer to apply a one-dimensional convolutional-based operation on the sampled data of the time-varying signals followed by a non-linear activation function layer on the sampled data of the time-varying signals under analysis.

The layers and blocks of the signal-analyzing neural-network 100 function similarly as described in FIG. 3. The signal-analyzing neural-network 100 in FIG. 3 has two branches. Each branch of the signal-analyzing neural-network 100 has four one-dimensional-convolution layers in series to act as filters, each one-dimensional-convolution layer followed by a non-linear activation function layer on the sampled data of the time-varying signals, a reshaping block, two dense layers, and multiple drop out layers. The final portion contains a concatenation layer and two dense layers.

The device with one or more processors, and a memory, can also have a radio frequency transmitter, and one or more antennas. The device is implemented in a Linear Frequency Modulated (LFM) Pulse-Doppler radar cooperating with a computing device with the machine learning architecture that uses the signal-analyzing neural-network 100 to analyze the sampled complex values of the radio frequency signals under analysis.

The machine learning architecture that uses the signal-analyzing neural-network 100 uses one-dimensional convolution operations on the time and frequency domains separately and combines these representations at a later layer of the neural network. This helps identify and classify different reflections of electromagnetic signals without prior knowledge of their presence or type in the scene. In this example, the signal-analyzing neural-network 100 operates on complex-valued radio frequency data in order to produce a classification of an entity. The complex values of the radio frequency signals under analysis are supplied to the signal-analyzing neural-network 100 as a data structure of a matrix with real and imaginary values and then the signal-analyzing neural-network 100 expands a 1-dimensional time signal into an 8-dimensional time-and-frequency representation. The data structure is a multiple dimension matrix that can contain values of both real-valued and an imaginary valued data. Again, the one-dimensional complex-valued signal can be represented as a real-valued 8-dimensional matrix with real-imaginary, magnitude, and phase values for both the time-domain representation of the signal, and its corresponding frequency-domain.

More Training Information

Prior to deployment of the neural network composed of two or more branches, the neural network composed of two or more branches is trained with one or more supervised machine learning algorithms on sampled data to take in an input of the sampled data X, and produce a correct truth value, y, where truth-value y of the entity is assigned a class label/is classified into a specific category of object such as “UAS,” “bird,” “rocket,” etc. This is true for the example where the source is an object that has specific categories of objects such as “UAS,” “bird,” “rocket,” etc. When other sources are used then the labels will correspond to the specific categories for that source.

The machine learning trains to automatically identify any signal types from the complex-valued RF data on which it is trained.

In one embodiment, the network was trained on randomly-parameterized signals that were generated, which were combined at random amplitudes, and to which were applied additive white gaussian noise at a random SNR ranging from −15 dB to 10 dB, as well as a random frequency shift to simulate imperfect basebanding prior to sampling. Each training example consisted of a 512×8 array generated from a single length-512 complex time-domain sample, as described above. 30,000 training examples were generated, and 5,000 validation examples were used to generate the accuracy metrics.

The machine learning architecture discussed herein may use many types of machine learning to train the signal-analyzing neural-network 100 capable of identifying objects from time varying signals into specific categories without needing a priori knowledge that a candidate is in the scene being analyzed. For example, the machine learning system 124 may apply one or more of nearest neighbor, naive Bayes, decision trees, linear regression, support vector machines, neural networks, k-Means clustering, Q-learning, temporal difference, deep adversarial networks, or other supervised, unsupervised, semi-supervised, or reinforcement learning algorithms to train one or more models for a suitable training set of previous time-varying signals such as electromagnetic signals flying through the air.

The machine learning architecture cooperating with the output module to automatically identify any signal types from the complex-valued RF data on which it is trained.

In one embodiment, this architecture was trained to classify Phase-Modulated Radar, Frequency Modulated Radar, and OFDM communications signals. Initial results show 97% accuracy for this reduced set of signal classes, which were combined and overlaid to test the robustness of the architecture. This can be shown in a confusion matrix. Note that accuracy starts to suffer significantly—requiring more training data and time—on signals below −5 dB SNR.

Modern ML architectures are often parameterized according to heuristics, and a more artistic than scientific approach. This can lead to a lack of model interpretability, and sub-optimal performance: a network can succeed according to accuracy metrics, while simultaneously performing far more computation than necessary. To address this efficiently, a flexible library known as Ray has been developed to work with TensorFlow. Ray allows a rapid, systematic sweeping of the hyperparameters which define a neural network, with a convenient integration into the TensorBoard platform commonly used with TensorFlow-based architectures. The Ray dashboard will permit an embodiment of the disclosed apparatuses and methods to minimize the network's size while improving training efficiency.

While the focus has primarily been on the automotive radar, frequency-hopping spread spectrum, and OFDM QAM signals, the disclosed system and methods could also include a wider variety of signals such as those specific to Bluetooth, WiFi, and common cellular modulations such as Cyclic-Prefix OFDM. In one embodiment, the signal generation suite is built upon Matlab libraries, which will allow these extensions flexibly. In addition, more realistic channel models—including background signals taken from existing data captures—will enhance the robustness of the network, and reduce misclassification. Finally, the addition of multipath propagation will further buttress the fast classification of the one-dimensional-convolution neural-network (CNN) architecture.

The techniques described in this disclosure may be implemented, at least in part, in hardware, software, firmware, or any combination thereof. For example, various aspects of the described techniques may be implemented within one or more processors, including one or more microprocessors, digital signal processors (DSPs), application specific integrated circuits (ASICs), field programmable gate arrays (FPGAs), or any other equivalent integrated or discrete logic circuitry, as well as any combinations of such components. The term “processor” or “processing circuitry” may generally refer to any of the foregoing logic circuitry, alone or in combination with other logic circuitry, or any other equivalent circuitry. A control unit comprising hardware may also perform one or more of the techniques of this disclosure. A module may be implemented in software stored in a memory and executed by one or more processors, in electronic hardware such as logic circuits, and any combination of both.

Network

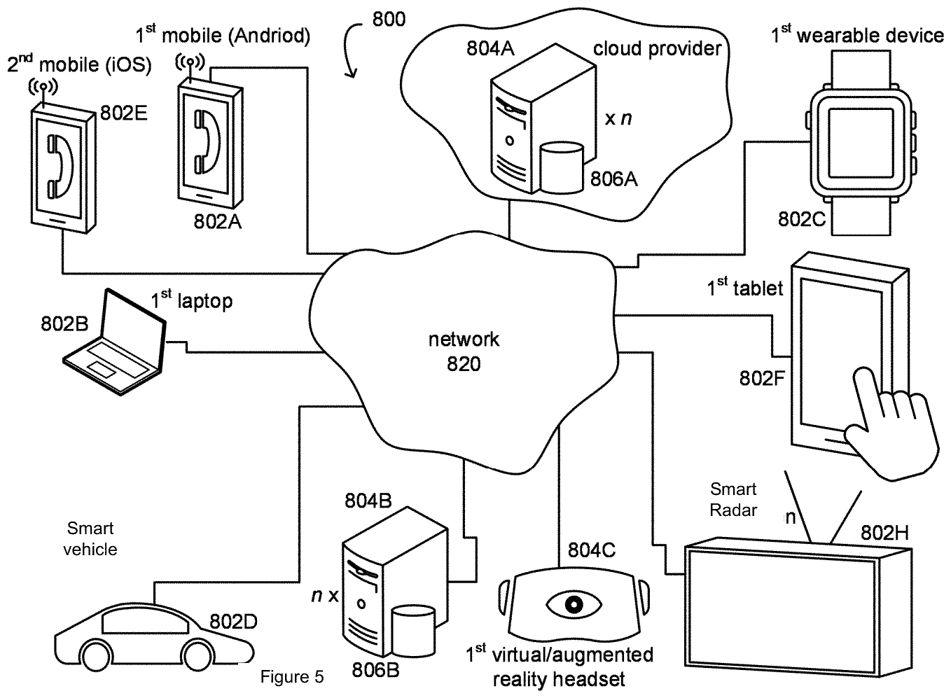

FIG. 5 illustrates a diagram of a number of electronic systems and devices communicating with each other in a network environment in accordance with an embodiment of the device with the machine learning architecture that use a signal-analyzing neural-network. The network environment 800 has a communications network 820. The network 820 can include one or more networks selected from an optical network, a cellular network, the Internet, a Local Area Network (“LAN”), a Wide Area Network (“WAN”), a satellite network, a fiber network, a cable network, and combinations thereof. In an embodiment, the communications network 820 is the Internet. As shown, there may be many server computing systems and many client computing systems connected to each other via the communications network 820. However, it should be appreciated that, for example, a single client computing system can also be connected to a single server computing system. Thus, any combination of server computing systems and client computing systems may connect to each other via the communications network 820.

The communications network 820 can connect one or more server computing systems selected from at least a first server computing system 804A and a second server computing system 804B to each other and to at least one or more client computing systems as well. The server computing system 804A can be, for example, the one or more server systems. The server computing systems 804A and 804B can each optionally include organized data structures such as databases 806A and 806B. Each of the one or more server computing systems can have one or more virtual server computing systems, and multiple virtual server computing systems can be implemented by design. Each of the one or more server computing systems can have one or more firewalls to protect data integrity.

The at least one or more client computing systems can be selected from a first mobile computing device 802A (e.g., smartphone with an Android-based operating system), a second mobile computing device 802E (e.g., smartphone with an iOS-based operating system), a first wearable electronic device 802C (e.g., a smartwatch), a first portable computer 802B (e.g., laptop computer), a third mobile computing device or second portable computer 802F (e.g., tablet with an Android- or iOS-based operating system), a smart device or system incorporated into a first smart vehicle with the radar system using the machine learning architecture 802D, a smart device or system incorporating the radar system using the machine learning architecture 802G, and the like. The device using the machine learning architecture can communicate and cooperate with other devices in the communications network 820. The client computing system 802B can be, for example, one of the one or more client systems 210, and any one or more of the other client computing systems (e.g., 802A, 802C, 802D, 802E, 802F, 802G, 802H, and/or 804C) can include, for example, the software application or the hardware-based system in which the trained machine learning architecture can be deployed. Each of the one or more client computing systems can have one or more firewalls to protect data integrity.

It should be appreciated that the use of the terms “client computing system” and “server computing system” is intended to indicate the system that generally initiates a communication and the system that generally responds to the communication. For example, a client computing system can generally initiate a communication and a server computing system generally responds to the communication. No hierarchy is implied unless explicitly stated. Thus, if the first portable computer 802B (e.g., the client computing system) and the server computing system 804A can both initiate and respond to communications, their communications can be viewed as peer-to-peer. Additionally, the server computing systems 804A and 804B include circuitry and software enabling communication with each other across the network 820. Server 804B may send, for example, simulator data to server 804A.

Any one or more of the server computing systems can be a cloud provider. A cloud provider can install and operate application software in a cloud (e.g., the network 820 such as the Internet) and cloud users can access the application software from one or more of the client computing systems. Generally, cloud users that have a cloud-based site in the cloud cannot solely manage a cloud infrastructure or platform where the application software runs. Thus, the server computing systems and organized data structures thereof can be shared resources, where each cloud user is given a certain amount of dedicated use of the shared resources. Each cloud user's cloud-based site can be given a virtual amount of dedicated space and bandwidth in the cloud. Cloud applications can be different from other applications in their scalability, which can be achieved by cloning tasks onto multiple virtual machines at run-time to meet changing work demand. Load balancers distribute the work over the set of virtual machines. This process is transparent to the cloud user, who sees only a single access point.

Cloud-based remote access can be coded to utilize a protocol, such as Hypertext Transfer Protocol (“HTTP”), to engage in a request and response cycle with an application on a client computing system such as a web-browser application resident on the client computing system. The cloud-based remote access can be accessed by a smartphone, a desktop computer, a tablet, or any other client computing systems, anytime and/or anywhere. The cloud-based remote access is coded to engage in 1) the request and response cycle from all web browser based applications, 3) the request and response cycle from a dedicated on-line server, 4) the request and response cycle directly between a native application resident on a client device and the cloud-based remote access to another client computing system, and 5) combinations of these.

In an embodiment, the server computing system 804A can include a server engine, a web page management component or direct application component, a content management component, and a database management component. The server engine can perform basic processing and operating-system level tasks. The web page management component can handle creation and display or routing of web pages or screens associated with receiving and providing digital content and digital advertisements, through a browser. Likewise, the direct application component may work with a client app resident on a user's device. Users (e.g., cloud users) can access one or more of the server computing systems by means of a Uniform Resource Locator (“URL”) associated therewith. The content management component can handle most of the functions in the embodiments described herein. The database management component can include storage and retrieval tasks with respect to the database, queries to the database, and storage of data.

In an embodiment, a server computing system can be configured to display information in a window, a web page, or the like. An application including any program modules, applications, services, processes, and other similar software executable when executed on, for example, the server computing system 804A, can cause the server computing system 804A to display windows and user interface screens in a portion of a display screen space.

Each application has a code scripted to perform the functions that the software component is coded to carry out such as presenting fields to take details of desired information. Algorithms, routines, and engines within, for example, the server computing system 804A can take the information from the presenting fields and put that information into an appropriate storage medium such as a database (e.g., database 806A). A comparison wizard can be scripted to refer to a database and make use of such data. The applications may be hosted on, for example, the server computing system 804A and served to the specific application or browser of, for example, the client computing system 802B. The applications then serve windows or pages that allow entry of details.

Computing Systems

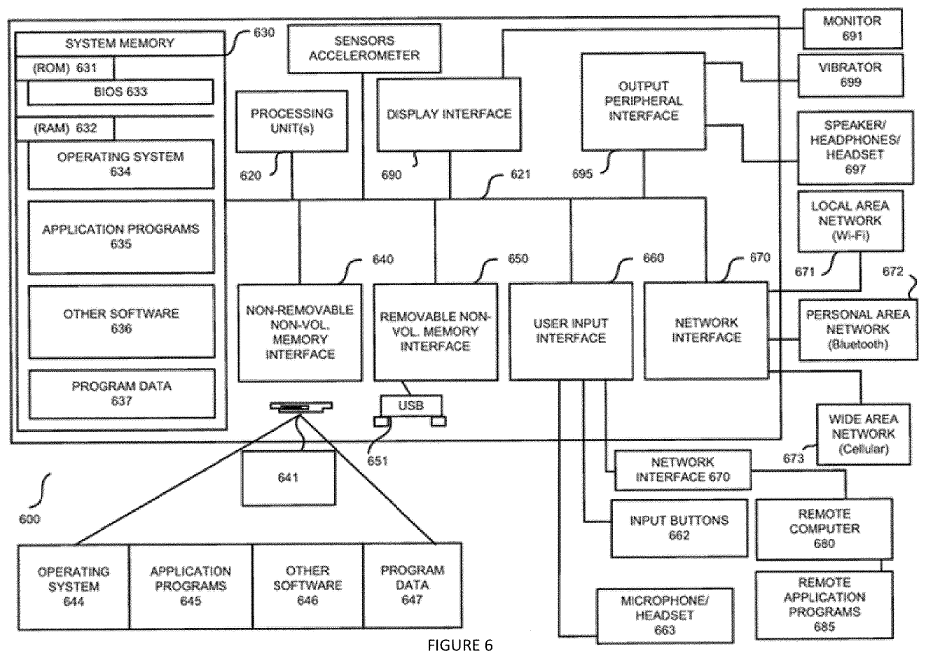

FIG. 6 illustrates a diagram of an embodiment of a computing device that can be a part of the systems associated with the device and its associated modules and the machine learning architecture discussed herein. The computing device 600 may include one or more processors or processing units 620 to execute instructions, one or more memories 630-632 to store information, one or more data input components 660-663 to receive data input from a user of the computing device 600, one or more modules that include the management module, a network interface communication circuit 670 to establish a communication link to communicate with other computing devices external to the computing device, one or more sensors where an output from the sensors is used for sensing a specific triggering condition and then correspondingly generating one or more preprogrammed actions, a display screen 691 to display at least some of the information stored in the one or more memories 630-632 and other components. Note, portions of this system that are implemented in software 644, 645, 646 may be stored in the one or more memories 630-632 and are executed by the one or more processors 620.

As discussed, the device and its associated modules and the machine learning architecture can be implemented with aspects of the computing device. The output module can work with one or more processors to execute instructions and a memory to store data and instructions. The output module cooperates with a machine learning architecture to analyze parameter-varying signals. The machine learning architecture uses a signal-analyzing neural-network. The signal-analyzing neural-network is trained with one or more machine learning algorithms on sampled data of the parameter-varying signals. The signal-analyzing neural-network contains at least a one-dimensional-convolution layer to apply a series of i) a one-dimensional convolutional-based operation on the data of the time-varying signals ii) followed by a non-linear activation function on the data of the parameter-varying signals, under analysis, with multiple representations of the parameter-varying signals. Each representation of the parameter-varying signal is analyzed in a different domain. Each representation of the parameter-varying signal is analyzed in a different domain with the series of i) the one-dimensional convolutional-based operation on the data of the time-varying signals ii) followed by the non-linear activation function on the data of the parameter-varying signals, under analysis, in order to produce a classification of an entity into a specific category of an object corresponding to identifying features of the parameter-varying signals.

The system memory 630 includes computer storage media in the form of volatile and/or nonvolatile memory such as read-only memory (ROM) 631 and random access memory (RAM) 632. These computing machine-readable media can be any available media that can be accessed by computing system 600. By way of example, and not limitation, computing machine-readable media use includes storage of information, such as computer-readable instructions, data structures, other executable software, or other data. Computer-storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other tangible medium which can be used to store the desired information and which can be accessed by the computing device 600. Transitory media such as wireless channels are not included in the machine-readable media. Communication media typically embody computer readable instructions, data structures, other executable software, or other transport mechanism and includes any information delivery media.

The system further includes a basic input/output system 633 (BIOS) containing the basic routines that help to transfer information between elements within the computing system 600, such as during start-up, is typically stored in ROM 631. RAM 632 typically contains data and/or software that are immediately accessible to and/or presently being operated on by the processing unit 620. By way of example, and not limitation, the RAM 632 can include a portion of the operating system 634, application programs 635, other executable software 636, and program data 637.

The computing system 600 can also include other removable/non-removable volatile/nonvolatile computer storage media. By way of example only, the system has a solid-state memory 641. The solid-state memory 641 is typically connected to the system bus 621 through a non-removable memory interface such as interface 640, and USB drive 651 is typically connected to the system bus 621 by a removable memory interface, such as interface 650.

A user may enter commands and information into the computing system 600 through input devices such as a keyboard, touchscreen, or software or hardware input buttons 662, a microphone 663, a pointing device and/or scrolling input component, such as a mouse, trackball or touch pad. These and other input devices are often connected to the processing unit 620 through a user input interface 660 that is coupled to the system bus 621, but can be connected by other interface and bus structures, such as a parallel port, game port, or a universal serial bus (USB). A display monitor 691 or other type of display screen device is also connected to the system bus 621 via an interface, such as a display interface 690. In addition to the monitor 691, computing devices may also include other peripheral output devices such as speakers 697, a vibrator 699, and other output devices, which may be connected through an output peripheral interface 695.

The computing system 600 can operate in a networked environment using logical connections to one or more remote computers/client devices, such as a remote computing system 680. The remote computing system 680 can a personal computer, a mobile computing device, a server, a router, a network PC, a peer device or other common network node, and typically includes many or all of the elements described above relative to the computing system 600. The logical connections can include a personal area network (PAN) 672 (e.g., Bluetooth®), a local area network (LAN) 671 (e.g., Wi-Fi), and a wide area network (WAN) 673 (e.g., cellular network), but may also include other networks such as a personal area network (e.g., Bluetooth®). Such networking environments are commonplace in offices, enterprise-wide computer networks, intranets and the Internet. A browser application may be resonant on the computing device and stored in the memory.

When used in a LAN networking environment, the computing system 600 is connected to the LAN 671 through a network interface 670, which can be, for example, a Bluetooth® or Wi-Fi adapter. When used in a WAN networking environment (e.g., Internet), the computing system 600 typically includes some means for establishing communications over the WAN 673. With respect to mobile telecommunication technologies, for example, a radio interface, which can be internal or external, can be connected to the system bus 621 via the network interface 670, or other appropriate mechanism. In a networked environment, other software depicted relative to the computing system 600, or portions thereof, may be stored in the remote memory storage device. By way of example, and not limitation, the system has remote application programs 685 as residing on remote computing device 680. It will be appreciated that the network connections shown are examples and other means of establishing a communications link between the computing devices that may be used.

As discussed, the computing system 600 can include mobile devices with a processing unit 620, a memory (e.g., ROM 631, RAM 632, etc.), a built in battery to power the computing device, an AC power input to charge the battery, a display screen, a built-in Wi-Fi circuitry to wirelessly communicate with a remote computing device connected to network.

It should be noted that the present design can be carried out on a computing system such as that described with respect to shown herein. However, the present design can be carried out on a server, a computing device devoted to message handling, or on a distributed system in which different portions of the present design are carried out on different parts of the distributed computing system.

In some embodiments, software used to facilitate algorithms discussed herein can be embedded onto a non-transitory machine-readable medium. A machine-readable medium includes any mechanism that stores information in a form readable by a machine (e.g., a computer). For example, a non-transitory machine-readable medium can include read-only memory (ROM); random access memory (RAM); magnetic disk storage media; optical storage media; flash memory devices; Digital Versatile Disc (DVD's), EPROMs, EEPROMs, FLASH memory, magnetic or optical cards, or any type of media suitable for storing electronic instructions.

Note, an application described herein includes but is not limited to software applications, mobile applications, and programs that are part of an operating system application. Some portions of this description are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like. These algorithms can be written in a number of different software programming languages such as C, C++, HTTP, Java, Python, or other similar languages. Also, an algorithm can be implemented with lines of code in software, configured logic gates in software, or a combination of both. In an embodiment, the logic consists of electronic circuits that follow the rules of Boolean Logic, software that contain patterns of instructions, or any combination of both. Any portions of an algorithm implemented in software can be stored in an executable format in portion of a memory and is executed by one or more processors. In an embodiment, a module can be implemented with electronic circuits, software being stored in a memory and executed by one or more processors, and any combination of both.

It should be borne in mind, however, that all of these and similar terms are to be associated with the appropriate physical quantities and are merely convenient labels applied to these quantities. Unless specifically stated otherwise as apparent from the above discussions, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers, or other such information storage, transmission or display devices.

Many functions performed by electronic hardware components can be duplicated by software emulation. Thus, a software program written to accomplish those same functions can emulate the functionality of the hardware components in input-output circuitry. Thus, provided herein are one or more non-transitory machine-readable medium configured to store instructions and data that when executed by one or more processors on the computing device of the foregoing system, causes the computing device to perform the operations outlined as described herein.

References in the specification to “an embodiment,” “an example”, etc., indicate that the embodiment or example described may include a particular feature, structure, or characteristic, but every embodiment may not necessarily include the particular feature, structure, or characteristic. Such phrases can be not necessarily referring to the same embodiment. Further, when a particular feature, structure, or characteristic is described in connection with an embodiment, it is believed to be within the knowledge of one skilled in the art to affect such feature, structure, or characteristic in connection with other embodiments whether or not explicitly indicated.

While the foregoing design and embodiments thereof have been provided in considerable detail, it is not the intention of the applicant(s) for the design and embodiments provided herein to be limiting. Additional adaptations and/or modifications are possible, and, in broader aspects, these adaptations and/or modifications are also encompassed. Accordingly, departures may be made from the foregoing design and embodiments without departing from the scope afforded by the following claims, which scope is only limited by the claims when appropriately construed.

What is claimed is:

1. An apparatus, comprising:
an output module configured to work with one or more processors to execute instructions and a memory to store data and instructions, where the output module is configured to cooperate with a machine learning architecture to analyze parameter-varying signals, and
where the machine learning architecture is configured to use a signal-analyzing neural-network, where the signal-analyzing neural-network is trained with one or more machine learning algorithms on sampled data of the parameter-varying signals, where the signal-analyzing neural-network is configured to contain a one-dimensional-convolution layer to apply a series of i) a one-dimensional convolutional-based operation on the data of the parameter-varying signals ii) followed by a non-linear activation function on the data of the parameter-varying signals with multiple representations of the parameter-varying signals, where each representation of the parameter-varying signal is analyzed in a different domain, in order to produce a classification of an entity into a specific category of an object corresponding to identifying features of the parameter-varying signals.

2. The apparatus of claim 1, where a multiple value data structure is utilized to supply different values of the parameter-varying signals to the signal-analyzing neural-network, where the parameter-varying signals under analysis are time-varying signals.

3. The apparatus of claim 2, where one or more branches of the signal-analyzing neural-network are constructed to apply at least two or more successive layers of the one-dimensional-convolution layer to apply the one-dimensional-convolution based operation followed by a non-linear activation function layer to apply the non-linear activation function to data values of time and frequency in the time-varying signals.

4. The apparatus of claim 3, where the signal-analyzing neural-network is a convolutional neural network architecture.

5. The apparatus of claim 2, where one or more portions of the signal-analyzing neural-network are constructed to include
a first branch where input values of the time-varying signals in a first domain are supplied into the first branch of the signal-analyzing neural-network, where a first one-dimensional-convolution layer in the first branch is configured to apply the one-dimensional convolutional-based operation on the input values of the time-varying signals in the first domain, and
a second branch where input values of the time-varying signals in a second domain are supplied into the second branch of the signal-analyzing neural-network, where a second one-dimensional-convolution layer in the second branch is configured to apply the one-dimensional convolutional-based operation on the input values of the time-varying signals in a second domain at a same time with operations in the first branch.

6. The apparatus of claim 1, where a first output result in a first domain is generated by a first branch of the signal-analyzing neural-network, and where a second output result in a second domain is generated by a second branch of the signal-analyzing neural-network, where the first and second output results from the first branch on the first domain and the second branch on the second domain of the signal-analyzing neural-network are combined in a concatenation layer of a later portion of the signal-analyzing neural network.

7. The apparatus of claim 1, where the signal-analyzing neural-network has a final portion of the signal-analyzing neural-network containing a concatenation layer to combine the multiple representations from the different domains and one or more fully connected layers that are configured to determine the specific category of the object from a group of two or more possible categories of objects.

8. The apparatus of claim 2, where the signal-analyzing neural-network contains a sequence of multiple iterations of one-dimensional convolutional layers, where each one-dimensional convolutional layer is configured to apply the one-dimensional convolutional-based operation followed by the non-linear activation function layer in order to change each output of each one-dimensional convolutional layer from a linear feature of the time-varying signal into a non-linear feature.

9. The apparatus of claim 1, further comprising:
a user interface configured to convey the produced classification of the entity into the specific category of the object corresponding to identifying features of the parameter-varying signals from a group of two or more possible categories of the object.

10. The apparatus of claim 2, where a multiple value data structure is configured to supply different values of sampled data of the time-varying signals as a matrix to supply the different values as a one-dimensional time signal that is expanded into a multiple dimensional time-and-frequency representation via operations performed by a preprocessing portion of the signal-analyzing neural-network.

11. The apparatus of claim 2, where the time-varying signals are radio frequency signals.

12. A method for a machine learning architecture, comprising:
using the machine learning architecture with a signal-analyzing neural-network to analyze data of parameter-varying signals, where the signal-analyzing neural-network is trained with one or more machine learning algorithms on data of the parameter-varying signals, and
using a one-dimensional-convolution layer in the signal-analyzing neural-network to apply a series of i) a one-dimensional convolutional-based operation on the data of the parameter-varying signals ii) followed by a non-linear activation function on the data of the parameter-varying signals with multiple representations of the parameter-varying signals, where each representation of the parameter-varying signal is analyzed in a different domain, in order to produce a classification of an entity into a specific category of an object corresponding to identifying features of the parameter-varying signals.

13. A non-transitory machine-readable medium, which stores further instructions in the executable format by the one or more processors to cause operations as follows, comprising:
using a machine learning architecture with a signal-analyzing neural-network to analyze data of parameter-varying signals, where the signal-analyzing neural-network is trained with one or more machine learning algorithms on data of the parameter-varying signals, and
using a one-dimensional-convolution layer in the signal-analyzing neural-network to apply a series of i) a one-dimensional convolutional-based operation on the data of the parameter-varying signals ii) followed by a non-linear activation function on the data of the parameter-varying signals with multiple representations of the parameter-varying signals, where each representation of the parameter-varying signal is analyzed in a different domain, in order to produce a classification of an entity into a specific category of an object corresponding to identifying features of the parameter-varying signals.

14. The non-transitory machine-readable medium of claim 13, which stores further instructions in the executable format by the one or more processors to cause further operations as follows, comprising:
where the parameter-varying signals under analysis are time-varying signals,
supplying input values of the time-varying signals in a time domain into a first branch of the signal-analyzing neural-network and then operating upon the time-varying signals in the time domain in the first branch of the signal-analyzing neural-network, where a first one-dimensional-convolution layer in the first branch is configured to apply the one-dimensional convolutional-based operation on the input values of the time-varying signals in the time domain, under analysis, and
supplying input values of the time-varying signals in a frequency domain into a second branch of the signal-analyzing neural-network and then operating upon the time-varying signals in the frequency domain in the second branch of the signal-analyzing neural-network, where a second one-dimensional-convolution layer in the second branch is configured to apply the one-dimensional convolutional-based operation on the input values of the time-varying signals in the frequency domain, under analysis.

15. The non-transitory machine-readable medium of claim 13, which stores further instructions in the executable format by the one or more processors to cause further operations as follows, comprising:
generating a first output result in a time domain in a first branch of the signal-analyzing neural-network,
generating a second output result in a frequency domain in a second branch of the signal-analyzing neural-network, and
combining the first and second output results from the first branch on the time domain and the second branch on the frequency domain of the signal-analyzing neural-network in a concatenation layer of a later portion of the signal-analyzing neural network.

16. The non-transitory machine-readable medium of claim 14, which stores further instructions in the executable format by the one or more processors to cause further operations as follows, comprising:
using a matrix to supply different values of the data of the time-varying signals under analysis as a one-dimensional time signal that is expanded into a multiple-dimensional time-and-frequency representation via operations performed by and within the signal-analyzing neural-network.

17. The non-transitory machine-readable medium of claim 14, which stores further instructions in the executable format by the one or more processors to cause further operations as follows, comprising:
using two or more successive layers of the one-dimensional-convolution layer to apply the one-dimensional-convolution based operation followed by a non-linear activation function layer to apply the non-linear activation function to the data of values of time and frequency features of the time-varying signals in order to change an output of the one-dimensional convolutional layer from a linear feature of the time-varying signal into a non-linear feature.

18. An apparatus, comprising:
a machine learning architecture configured to use a signal-analyzing neural-network, using the machine learning architecture with a signal-analyzing neural-network to analyze data of parameter-varying signals, where the signal-analyzing neural-network is trained with one or more machine learning algorithms on data of the parameter-varying signals, and
a one-dimensional-convolution layer in the signal-analyzing neural-network is configured to apply a series of i) a one-dimensional convolutional-based operation on the data of the parameter-varying signals ii) followed by a non-linear activation function on the data of the parameter-varying signals with multiple representations of the parameter-varying signals, where each representation of the parameter-varying signal is analyzed in a different domain in order to produce a classification of an entity into a specific category of an object corresponding to identifying features of the parameter-varying signals.

19. The apparatus of claim 18, where the parameter-varying signals under analysis are time-varying signals, and
where the signal-analyzing neural-network is constructed to include
i) a first branch where input values of the time-varying signals in a first domain are supplied into and operated upon in the first branch of the signal-analyzing neural-network, where a first one-dimensional-convolution layer in the first branch is configured to apply the one-dimensional convolutional-based operation on the input values of the time-varying signals in the first domain, under analysis, and
ii) a second branch where input values of the time-varying signals in a second domain are supplied into and operated upon in the second branch of the signal-analyzing neural-network, where a second one-dimensional-convolution layer in the second branch is configured to apply the one-dimensional convolutional-based operation on the input values of the time-varying signals in a second domain, under analysis, at a same time with operations in the first branch, where a first output result in the first domain is generated by the first branch of the signal-analyzing neural-network, and where a second output result in the second domain is generated by the second branch of the signal-analyzing neural-network, where the first and second output results from the first branch and the second branch of the signal-analyzing neural-network are combined in a later portion of the signal-analyzing neural network.

20. The apparatus of claim 18, where the neural network contains a sequence of multiple iterations of one-dimensional convolutional layers, where each one-dimensional convolutional layer is configured to apply the one-dimensional convolutional-based operation followed by the non-linear activation function in order to change each output of each one-dimensional convolutional layer from a linear feature of the parameter-varying signal into a non-linear feature.
